(19) United States
(12) Patent Application Publication
(10) Pub. No.: US 2026/0031321 A1
(43) Pub. Date: Jan. 29, 2026

(54) SLOT-DIE COATER

(71) Applicant: SK ON CO., LTD., Seoul (KR)

(72) Inventor: Ju Hyun KIM, Daejeon (KR)

(21) Appl. No.: 19/277,431

(22) Filed: Jul. 23, 2025

(30) Foreign Application Priority Data
Jul. 25, 2024 (KR) 10-2024-0098836

(51) Int. Cl. H01M 4/04

(52) U.S. Cl. CPC H01M 4/0411

(57) ABSTRACT

Proposed is a slot-die coater including an upper plate, a lower plate coupled with the upper plate, a shim frame coupled between the upper and lower plates, the shim frame having an open front portion, and a plurality of shim blocks coupled to one surface of the lower plate so as to cover the open front portion of the shim frame, wherein the shim block may be driven so as to protrude from above the one surface of the lower plate or be housed below the one surface of the lower plate. According to one embodiment, when discharging a coating solution through the slot-die coater and coating a substrate with this coating solution, the precise alignment of a shim member that forms a discharge part can be maintained, and the width and thickness of the discharge part can be effectively adjusted and controlled through automatic control via the shim blocks.

### CROSS REFERENCE TO RELATED APPLICATION

The present application claims priority to Korean Patent Application No. 10-2024-0098836, filed Jul. 25, 2024, the entire contents of which is incorporated herein for all purposes by this reference.

### BACKGROUND

### 1. Technical Field

The present disclosure relates to a slot-die coater.

### 2. Description of the Related Art

Recently, the size reduction and weight reduction of mobile information terminals such as mobile phones and laptops have been in progress. As the demand for higher capacity also increases in the fields of electric vehicles, hybrid vehicles, and the like, various types of batteries have been developed and used as power sources. Electrode plates used in such secondary batteries or capacitors are manufactured by making electrode powder into a slurry form and coating the surface of a support with this slurry, followed by drying.

In such a manufacturing process of electrode plates, there have been various problems with the operational reliability of existing devices becoming poor due to changes in the specifications, such as the amount of slurry coating solution, coating width, and slurry viscosity. To solve these problems, various coating devices and coating methods are being developed, and the need for automation of such devices or methods is also emerging.

### DOCUMENT OF RELATED ART

### Patent Document

(Patent Document 1) KR 2008-0024715 A

### SUMMARY

According to one aspect of the present disclosure, a slot-die coater that effectively prevents possible errors occurring in the process of coupling a shim member that forms a discharge part through which a coating solution is discharged and is capable of adjusting and controlling the thickness and width of the discharge part through one shim member and shim blocks may be provided.

According to another aspect of the present disclosure, a slot-die coater that is capable of automating an operation to optimize a shim member depending on various variables such as the loading amount and viscosity of a slurry in the process of coating a substrate with the slurry may be provided.

A slot-die coater, according to one embodiment of the present disclosure, includes: an upper plate, a lower plate coupled with the upper plate, a shim frame coupled between the upper and lower plates, the shim frame having an open front portion, and a plurality of shim blocks coupled to one surface of the lower plate so as to cover the open front portion of the shim frame, wherein the shim block may be driven so as to protrude from above the one surface of the lower plate or be housed below the one surface of the lower plate.

In this case, some of the plurality of shim blocks may be formed in a direction extending from both ends of the shim frame by protruding from above the one surface of the lower plate to a height corresponding to a thickness of the shim frame, and the remaining shim blocks may be formed so as to protrude from above the one surface of the lower plate to a height corresponding to a thickness smaller than that of the shim frame or be housed below the one surface of the lower plate, thus forming a discharge part between the upper and lower plates.

In addition, the shim frame may be coupled to the one surface of the lower plate while a part or all of a front portion of the lower plate is open, and the plurality of shim blocks may be continuously coupled in one direction on the one surface of the lower plate in the open front portion of the shim frame.

In addition, some of the plurality of shim blocks may be formed in a direction extending from both ends of the shim frame by protruding from above the one surface of the lower plate to a height corresponding to a thickness of the shim frame, and the remaining shim blocks may be formed so as to protrude from above the one surface of the lower plate to a height corresponding to a thickness smaller than that of the shim frame or be housed below the one surface of the lower plate, thus forming a discharge part between the upper and lower plates.

In addition, the shim block may include: a block part having a fastening groove an inner surface of which is formed of screw threads in an inward direction of a surface being opposite to a surface protruding from above the one surface of the lower plate, a rotary drive part an outer surface of which is formed of screw threads so as to be fastened to the fastening groove of the block part, the rotary drive part driving the block part upwardly and downwardly depending on a rotation direction, and a support part to which the rotary drive part is coupled so as to be rotatable.

In addition, the slot-die coater may further include a manifold to house a coating solution inside the lower plate.

In addition, the shim blocks that are protrudingly formed on the one surface of the lower plate at both ends of the discharge part formed between the upper and lower plates may include a chamfer part allowing an edge of the shim block to be tapered radially along a discharge direction of the discharge part.

The features and advantages of the present disclosure will become more apparent from the following detailed description based on the accompanying drawings.

Before discussing the description, it should be noted that all terms or words used herein and used in the appended claims should not be construed as general and dictionary meanings, but will be interpreted based on the meanings and concepts corresponding to the technical ideas of the present disclosure, following the principle that any inventor is allowed to define the concepts of terms as appropriate to describe the disclosure thereof in the best mode.

According to one embodiment of the present disclosure, in the process of coating a substrate with a coating solution using a slot-die coater, precise alignment of a shim member that forms a discharge part is possible, and the width and thickness of the discharge part can be effectively adjusted through automatic control via shim blocks.

In addition, positional errors occurring between the shim member and a lower plate can be fundamentally eliminated by arranging the shim blocks at the front portion of one surface of the lower plate, thus improving the operational reliability and precision of the slot-die coater.

In addition, the specifications of the discharge part can be appropriately and flexibly controlled depending on the loading amount or viscosity of a slurry by arranging and coupling a plurality of shim blocks on the one surface of the lower plate to automatically control the height of the shim block.

In addition, a side ring, which is caused by an increase in resistance resulting from a gap between coating rolls and a possible difference in viscosity at both ends of the coating width, can be effectively improved by forming a chamfer part at the edge of the shim blocks at both ends of the discharge part.

In addition, further precise control of the discharge part is possible by adjusting the number and width of shim blocks coupled to the lower plate. In addition, when fastening a shim frame, coupling errors caused by the shim blocks fixed to the lower plate can be minimized, thus reducing unnecessary loss of the coating solution or slurry and improving the coating discharge reliability of the slot-die coater.

### BRIEF DESCRIPTION OF THE DRAWINGS

FIG. 1 is a partially exploded perspective view illustrating a slot-die coater according to one embodiment of the present disclosure;

FIG. 2 is an exploded perspective view in which a shim frame of a slot-die coater, according to one embodiment of the present disclosure, is coupled;

FIG. 3 is a cross-sectional view illustrating a main part of a slot-die coater according to one embodiment of the present disclosure;

FIG. 4 is an exploded perspective view illustrating a shim block of a slot-die coater according to one embodiment of the present disclosure;

FIG. 5 is an operational schematic view in which an individual shim block of a slot-die coater, according to one embodiment of the present disclosure, protrudes from above one surface of a lower plate;

FIG. 6 is an operational schematic view in which an individual shim block of a slot-die coater, according to one embodiment of the present disclosure, is housed below one surface of a lower plate;

FIGS. 7 and 8 are side schematic views illustrating a discharge part of a slot-die coater according to one embodiment of the present disclosure; and

FIG. 9 is a plan view illustrating a coupled shim member of a slot-die coater according to one embodiment of the present disclosure.

### DETAILED DESCRIPTION

The terms used to describe one embodiment of the present disclosure are not intended to limit the present disclosure. It should be noted that singular expressions include plural expressions unless the context indicates otherwise.

In assigning reference numerals to elements in the drawings, the same elements are assigned the same reference numerals as much as possible throughout different drawings, and like elements are assigned like reference numerals.

In the drawings, the shape and size of elements may be schematically or exaggeratedly drawn to describe the embodiment. As used herein, expressions such as “have,” “may have,” “include,” “including,” “may include,” “comprise,” “comprising,” or the like specify the presence of stated features (for example, integers, functions, operations, or elements such as parts), but do not preclude the presence of other additional features.

Terms such as “one,” “other,” “another,” “first,” “second,” and the like are only used to distinguish one element from another, and such elements are not limited by these terms.

Hereinbelow, one embodiment of the present disclosure will be described in detail with reference to the accompanying drawings.

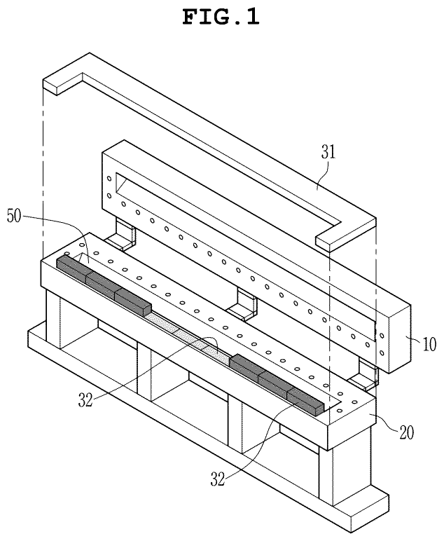

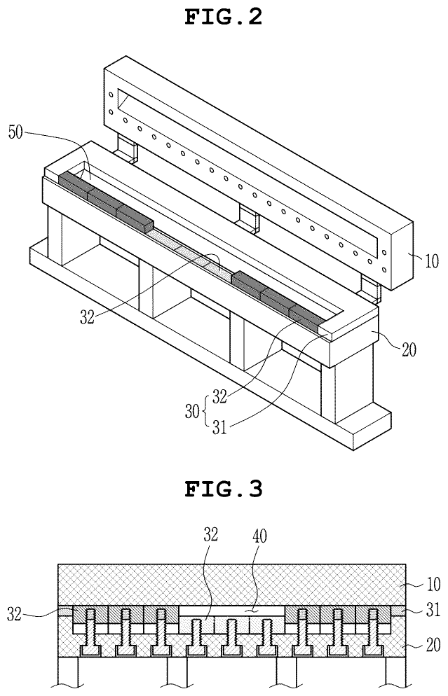

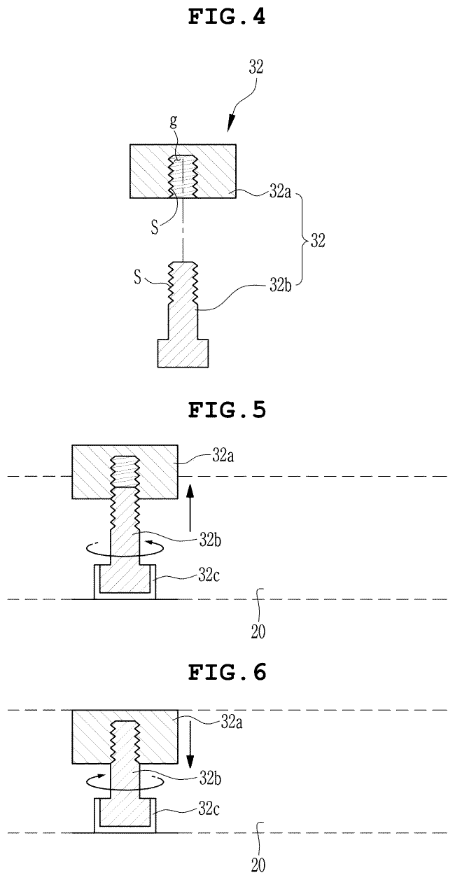

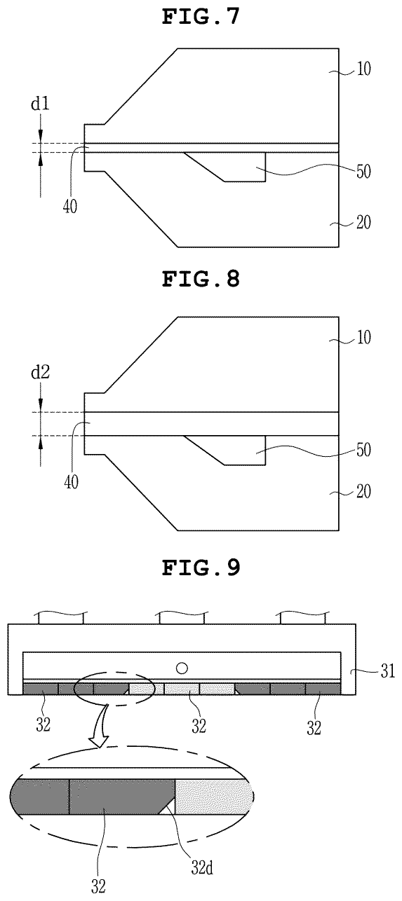

FIG. 1 is a partially exploded perspective view illustrating a slot-die coater according to one embodiment of the present disclosure; FIG. 2 is an exploded perspective view in which a shim frame of a slot-die coater, according to one embodiment of the present disclosure, is coupled; FIG. 3 is a cross-sectional view illustrating a main part of a slot-die coater according to one embodiment of the present disclosure; FIG. 4 is an exploded perspective view illustrating a shim block of a slot-die coater according to one embodiment of the present disclosure; FIG. 5 is an operational schematic view in which an individual shim block of a slot-die coater, according to one embodiment of the present disclosure, protrudes from above one surface of a lower plate; FIG. 6 is an operational schematic view in which an individual shim block of a slot-die coater, according to one embodiment of the present disclosure, is housed below one surface of a lower plate; FIGS. 7 and 8 are side schematic views illustrating a discharge part of a slot-die coater according to one embodiment of the present disclosure; and FIG. 9 is a plan view illustrating a coupled shim member of a slot-die coater according to one embodiment of the present disclosure.

A slot-die coater, according to one embodiment of the present disclosure, includes: an upper plate 10, a lower plate 20 coupled with the upper plate 10, a shim frame 31 coupled between the upper plate 10 and the lower plate 20, the shim frame 31 having an open front portion, and a plurality of shim blocks 32 coupled to one surface of the lower plate 20 so as to cover the open front portion of the shim frame 31, wherein the shim block 32 may be driven so as to protrude from above the one surface of the lower plate 20 or be housed below the one surface of the lower plate 20.

As illustrated in FIG. 1, the upper plate 10 and the lower plate 20 are formed in the slot-die coater according to one embodiment of the present disclosure, and a shim member 30 is coupled between the upper plate 10 and the lower plate 20 to form a discharge part 40.

As illustrated in FIG. 2, in one embodiment of the present disclosure, the shim member 30 may include the shim frame 31 formed on the one surface of the lower plate 20, and the plurality of shim blocks 32 coupled so as to cover the area of the open front portion of the shim frame 31. In this case, the shim frame 31 may be formed at the back and both sides of the lower plate 20, and the shim blocks 32 are arranged at the front portion of the lower plate 20.

It is apparent that the arrangement of the shim blocks 32 is not limited to the illustrated configuration, and the space where the shim frame 31 and the shim blocks 32 are arranged or the arrangement form thereof may be freely adjusted as needed. In addition, a manifold 50 capable of housing a coating solution or slurry may be formed inside the upper plate 10 or the lower plate 20, and the position or shape of the manifold 50 is not limited to those illustrated in the drawings.

The slot-die coater, according to one embodiment of the present disclosure, does not form the discharge part 40 in a form fixed to a single shim member 30, but is rather configured such that the shape of the discharge part 40 is controllable and adjustable according to the drive of the shim blocks 32 through the shim frame 31 having the open front portion and the plurality of shim blocks 32 arranged in the open front portion of the shim frame 31.

The area of the open front portion of the shim frame 31 may be designed so as to be entirely or partially opened as needed, and the shim frame 31 and shim block 32 may be combined in various sizes and lengths depending on the required specifications and area of the discharge part 40. The shim frame 31 and the shim block 32, constituting the shim member 30, may be combined in various sizes and lengths depending on the area or space of the discharge part 40.

In addition, the shim block 32 may be driven so as to protrude from above the one surface of the lower plate 20 or to be housed below the one surface of the lower plate 20. In other words, the width or thickness of the discharge part 40 may be precisely set through the combination of the shim frame 31 and the shim block 32, constituting the entire shim member 30, by adjusting the protrusion height or the number of protruding shim blocks 32.

The shim frame 31 used may be appropriately replaced or modified in accordance with the height of the protruding shim blocks 32, depending on specifications required in the coating processes.

As illustrated in FIG. 3, the shim member 30 is coupled between the upper plate 10 and the lower plate 20, and the discharge part 40 may be formed by the difference in height between the plurality of shim blocks 32 arranged at the front portion of the lower plate 20.

Some of the shim blocks 32 are housed below the one surface of the lower plate 20, and the remaining shim blocks 32 protrude from above the one surface of the lower plate 20 to a height corresponding to the thickness of the shim frame 31 by extending from both ends of the shim frame 31. By such shim blocks 32, the space of the discharge part 40 is formed.

In this case, the shim blocks 32 may be fully housed inside the lower plate 20 or protrude from above the one surface of the lower plate 20 to a height lower than the height of other shim blocks 32 and the height corresponding to the thickness of the shim frame 31 in some cases, thus adjusting the thickness of the discharge part 40.

The number, height, width, and the like of the shim blocks 32 may be flexibly selected depending on the conditions of target coating rolls or substrates, thus precisely setting the width and thickness ranges of the discharge part 40. In particular, to increase the operational precision, the plurality of shim blocks 32 may be arranged and coupled at a further smaller width.

Furthermore, all the shim blocks 32 may be formed with the same size and width, but may be configured to be arranged and coupled by combining the shim blocks 32 of various sizes as needed.

As illustrated in FIG. 4, the shim block 32 may include: a block part 32A that is capable of protruding from above the one surface of the lower plate 20 or being housed inside the lower plate 20, a rotary drive part 32B that rotates to drive the block part 32A upwardly and downwardly, and a support part 32C that enables the rotary drive part 32B to be fixed inside the lower plate 20 and rotatable.

Specifically, the block part 32A may be formed in a shape corresponding to the cross-sectional shape of the shim frame 31 or a rectangular shape and may be provided with a fastening groove G the inner surface of which is formed of screw threads S thereinside.

The rotary drive part 32B has screw threads S on the outer surface thereof and may drive the block part 32A upwardly and downwardly through rotation by engaging with the fastening groove G of the block part 32A. In this process, the block part 32A may be coupled closely with the neighboring block parts 32A and linearly driven in a closely compacted form.

The rotary drive part 32B is coupled to the support part 32C inside the lower plate 20, and the support part 32C may include a bearing so that the rotary drive part 32B is smoothly rotatable.

In addition, despite not being illustrated in the present disclosure, it is apparent that a guide configured to prevent shaking or change of direction when driving the block part 32A upwardly and downwardly may be separately formed on the housing part inside the lower plate 20.

It is apparent that the upward and downward drive of the block part 32A is not limited to the illustrated example of the present disclosure and may be implemented through other known methods, such as bolt fastening.

As illustrated in FIG. 5, in the shim block 32 according to one embodiment of the present disclosure, the block part 32A may be upwardly driven as the rotary drive part 32B rotates in one direction. As a result, the block part 32A protrudes out of the one surface of the lower plate 20, thus adjusting the height of the discharge part 40.

On the contrary, as illustrated in FIG. 6, when the rotary drive part 32B rotates in the opposite direction, the block part 32A may be downwardly driven and thus housed inside the lower plate 20.

In this case, the block part 32A may be fully housed inside the lower plate 20 or may be adjusted to protrude by a predetermined height as needed.

By adjusting the protrusion height of the shim block 32 from above the one surface of the lower plate 20 in such a manner, the number of shim blocks 32 at a height the same as that of the shim frame 31 and the number of shim blocks 32 at a height relatively lower than that of the shim frame 31 may be combined, thus adjusting the width of the discharge part 40. In addition, the discharge thickness of the discharge part 40 may be adjusted through the difference in protrusion height between the shim blocks 32. This allows the coating process to be precisely controllable in accordance with the characteristics of the coating solution or slurry and the specifications of the target coating rolls.

As illustrated in FIGS. 7 and 8, a difference in D1 and D2, each of which is the thickness of the discharge part 40 of the slot-die coater, may also be precisely realized by only adjusting the height of the shim block 32, according to the present disclosure. Such a configuration allows for partial adjustment of the specifications of the discharge part 40 without disassembling the entire slot-die coater, thus effectively shortening the lead time of product manufacturing processes.

As illustrated in FIG. 9, the respective shim blocks 32 at both ends of the discharge part 40, formed between the upper plate 10 and the lower plate 20, are protrudingly formed, and a chamfer part 32D tapered radially along the discharge direction may be formed at the edge of the two shim blocks 32.

There have been problems in that significant resistance is generated due to the rectangular shape formed by the coating width defined by the discharge part 40, namely, the gap between the slot-die coater and the coating roll, the target roll for coating, at both ends of the discharge part 40 in the width direction.

Accordingly, as illustrated in FIG. 9, the chamfer part 32D that is chamfered in the outer direction of the discharge direction may be formed on the shim block 32 at both ends of the discharge part 40, thus effectively reducing the resistance generated during discharge.

The chamfer part 32D may be formed by machining a part of the edge of the shim block 32 in a tapered manner. In some cases, the entire one end of the shim block 32 may be formed to have a slope in the outward direction. In this case, the direction, angle, size, and the like of the slope are appropriately adjustable depending on the conditions of coating processes.

The present disclosure has been described in detail through specific embodiments. These embodiments are intended to specifically describe the present disclosure, and what is disclosed herein is only for illustrative purposes of the present disclosure, not for limiting the appended claims. It is apparent to those skilled in the art that various modifications and alternatives may be made to the embodiments without departing from the technical idea and scope of the present disclosure, and such modifications and alternatives fall within the scope of the appended claims.

What is claimed is:

1. A slot-die coater comprising:
an upper plate;
a lower plate coupled with the upper plate;
a shim frame coupled between the upper and lower plates, the shim frame having an open front portion; and
a plurality of shim blocks coupled to one surface of the lower plate so as to cover the open front portion of the shim frame,
wherein the shim block is driven so as to protrude from above the one surface of the lower plate or be housed below the one surface of the lower plate.

2. The slot-die coater of claim 1, wherein some of the plurality of shim blocks is formed in a direction extending from both ends of the shim frame by protruding from above the one surface of the lower plate to a height corresponding to a thickness of the shim frame, and
the remaining shim blocks are formed so as to protrude from above the one surface of the lower plate to a height corresponding to a thickness smaller than that of the shim frame or be housed below the one surface of the lower plate, thus forming a discharge part between the upper and lower plates.

3. The slot-die coater of claim 1, wherein the shim frame is coupled to the one surface of the lower plate while a part or all of a front portion of the lower plate is open, and
the plurality of shim blocks is continuously coupled in one direction on the one surface of the lower plate in the open front portion of the shim frame.

4. The slot-die coater of claim 3, wherein some of the plurality of shim blocks are formed in a direction extending from both ends of the shim frame by protruding from above the one surface of the lower plate to a height corresponding to a thickness of the shim frame, and
the remaining shim blocks are formed so as to protrude from above the one surface of the lower plate to a height corresponding to a thickness smaller than that of the shim frame or be housed below the one surface of the lower plate, thus forming a discharge part between the upper and lower plates.

5. The slot-die coater of claim 3, wherein the shim block comprises:
a block part having a fastening groove an inner surface of which is formed of screw threads in an inward direction of a surface being opposite to a surface protruding from above the one surface of the lower plate;
a rotary drive part an outer surface of which is formed of screw threads so as to be fastened to the fastening groove of the block part, the rotary drive part driving the block part upwardly and downwardly depending on a rotation direction; and
a support part to which the rotary drive part is coupled so as to be rotatable.

6. The slot-die coater of claim 1, further comprising a manifold to house a coating solution inside the lower plate.

7. The slot-die coater of claim 2, wherein the shim blocks that are protrudingly formed on the one surface of the lower plate at both ends of the discharge part formed between the upper and lower plates comprise:
a chamfer part allowing an edge of the shim block to be tapered radially along a discharge direction of the discharge part.
